(19) United States
(12) Patent Application Publication
(10) Pub. No.: US 2019/0240730 A1
(43) Pub. Date: Aug. 8, 2019

(54) 3D PRINTING INTO A LIQUID MEDIUM

(71) Applicant: Desktop Metal, Inc., Burlington, MA (US)

(72) Inventors: Charles John Haider, Cambridge, MA (US); Michael Andrew Gibson, Boston, MA (US); Richard Remo Fontana, Cape Elizabeth, ME (US); Alexander C. Barbati, Cambridge, MA (US)

(21) Appl. No.: 15/887,071

(22) Filed: Feb. 2, 2018

(51) Int. Cl. B22F 3/00; B28B 1/00; B29C 64/209; B29C 64/245; B29C 64/227; B29C 64/393; B28B 17/00; B33Y 30/00; B33Y 40/00; B33Y 50/02

(52) U.S. Cl. CPC B22F 3/008; B28B 1/001; B29C 64/209; B29C 64/245; B33Y 50/02; B29C 64/393; B28B 17/0081; B33Y 30/00; B33Y 40/00; B29C 64/227

(57) ABSTRACT

A three-dimensional printer includes a vessel containing a liquid in which a printed object can debind during fabrication. More generally, the vessel may contain any liquid medium selected to control or modify properties of a printed object during fabrication. For example, the liquid may also or instead impose a controlled thermal environment for the printed object, apply finishing materials to an exterior surface of the object, provide a component or catalyst for a reaction, or otherwise treat the printed object or control ambient conditions during printing.

### BACKGROUND

A three-dimensional printer includes a vessel containing a liquid in which a printed object can debind during fabrication. More generally, the vessel may contain any liquid medium selected to control or modify properties of a printed object during fabrication. For example, the liquid may also or instead impose a controlled thermal environment for the printed object, apply finishing materials to an exterior surface of the object, or otherwise treat the printed object or control ambient conditions during printing.

### SUMMARY

A three-dimensional printer includes a vessel containing a liquid in which a printed object can debind as it is fabricated. More generally, the vessel may contain any liquid medium selected to control or modify a printed object during fabrication. For example, the liquid may also or instead impose a controlled thermal environment for the printed object, apply finishing materials to an exterior surface of the object, provide a component or catalyst for a reaction, or otherwise treat the printed object or control ambient conditions during printing.

In one aspect, a printer for three-dimensional fabrication disclosed herein includes a source of a build material for fabricating an object, the build material including a first material and a second material, the first material including a discrete phase for forming a net shape of the object and sinterable into a densified mass, and the second material including one or more binders that resist deformation of the net shape of the object; a build plate to receive the object; an extruder coupled to the source of the build material and movable relative to the build plate, the extruder including a nozzle to extrude the build material during a fabrication process; a first robotic system operable to move the extruder along a build path relative to the build plate to fabricate the object on the build plate based on a computerized model of the object; a vessel containing a debinding liquid selected to remove at least one of the one or more binders from the object when the object is placed in contact with the debinding liquid; and a second robotic system operable to move the build plate within the vessel during fabrication of the object to controllably expose the build material to the debinding liquid.

The printer may further include a heater in communication with the vessel to maintain a predetermined temperature within the vessel. The predetermined temperature may include a temperature gradient between a top surface of contents of the vessel and a bottom surface of the vessel. The predetermined temperature may include a substantially consistent temperature for contents of the vessel. The printer may further include a plurality of heaters configured to spatially control a temperature distribution within the vessel. The printer may further include a level control system configured to maintain a predetermined position of a top surface of contents within the vessel. The level control system may include one or more of a drain in the vessel, a pump, a valve, and a controller. The level control system may include the drain in the vessel, wherein the drain includes an overflow drain. The printer may further include an overflow vat disposed about the vessel, the overflow vat in fluid communication with the overflow drain. The debinding liquid may include one or more of an aqueous solvent, a non-aqueous solvent, water, ethanol, oil, a catalytic debinder, trans-dichloroethylene, limonene, hexane, perchloroethylene, and heptane. The printer may further include a control system to vary a concentration of the debinding liquid during the fabrication process. The printer may further include a second medium in the vessel in addition to the debinding liquid. The printer may further include a spout operable to disperse a liquid into the vessel. The liquid may include the debinding liquid. The liquid may be sprayed onto the object. The liquid may be dispersed directly into the vessel without contacting the object. The printer may further include a circulation system operable to move the liquid between the vessel and the spout. The vessel may include an inlet and an outlet for distributing contents into and out of the vessel. The printer may further include a pump in fluid communication with the vessel, the pump operable to move contents of the vessel. The pump may be operable to control a fluid path of the debinding liquid through the vessel. The pump may be operable to circulate liquid contents within the vessel. The printer may further include a temperature sensor, wherein the pump is responsive to a sensed temperature to maintain a predetermined temperature distribution within the vessel. The first robotic system may be operable to move the extruder along a z-axis to fabricate a plurality of layers of the object. The second robotic system may be operable to move the build plate at a rate selected to minimize disturbances at a top surface of contents of the vessel. The printer may further include a processor configured by computer executable code to move the first robotic system and the second robotic system. The processor may be configured to alter the build path based on a dimensional characteristic of the object that changes when contacting contents of the vessel. One or more of the first robotic system and the second robotic system may be configured to maintain a predetermined separation of the nozzle and contents of the vessel. The build plate may be porous. The build plate may include one or more fluid channels to expose a bottom surface of the object adjacent to the build plate to the debinding liquid in the vessel.

In one aspect, a printer for three-dimensional fabrication disclosed herein includes a source of a build material for fabricating an object, the build material including a first material and a second material, the first material including a discrete phase for forming a net shape of the object and sinterable into a densified mass, and the second material including one or more binders that resist deformation of the net shape of the object; a vessel containing a debinding medium selected to remove at least one of the one or more binders from the object when the object is placed in contact with the debinding medium; a surface within the vessel to receive the object as the object is formed layer by layer at a printing plane during a fabrication process; a first robotic system operable to control formation of the object during the fabrication process; and a second robotic system operable to move one or more of the surface, the vessel, and the printing plane during fabrication of the object to controllably expose the build material to the debinding medium.

The debinding medium may include water, wherein at least one of the one or more binders is removed by exposure to water. The debinding medium may include a powder, wherein at least one of the one or more binders is removed by wicking into the powder. The powder may include a ceramic. The powder may include alumina. The powder may be coated onto the object during fabrication. The printer may further include a blower operable to provide a burst of gas to remove at least some of the powder after coating. The printer may further include an agitator operable to create an agitated flow of the powder for applying to the object. The debinding medium may include a non-aqueous solvent. The debinding medium may include a supercritical fluid. The supercritical fluid may include carbon dioxide. The debinding medium may include a catalytic debinding agent. The catalytic debinding agent may include one or more of gaseous nitric acid and gaseous oxalic acid. The surface may be included on a build plate movable by the second robotic system. The surface may be a top surface of contents of the vessel. The printer may further include a print head including one or more of an extruder and an inkjet head configured to deposit the build material to form the object.

In one aspect, a printer for three-dimensional fabrication disclosed herein includes a source of a build material for fabricating an object; a build plate to receive the object; an extruder coupled to the source of the build material and movable relative to the build plate, the extruder including a nozzle to deposit the build material during a fabrication process; a first robotic system operable to move the extruder along a build path relative to the build plate to fabricate the object on the build plate based on a computerized model of the object; a vessel containing a medium selected to change a property of the build material when the object is placed in contact with the medium; and a second robotic system operable to controllably expose the build material to the medium.

The medium may include a liquid. The medium may be selected to change one or more of a color and a texture of the build material of the object. The medium may be selected to remove at least a portion of the build material of the object. The build material may include a first material and a second material, the first material including a discrete phase for forming a net shape of the object and sinterable into a densified mass, and the second material including one or more binders that resist deformation of the net shape of the object, wherein the medium is selected to remove at least one of the one or more binders from the object. The medium may include at least two density-stratified materials. The at least two density-stratified materials may include at least one inert component and at least one reactive component with the first material. The at least two density-stratified materials may include at least one inert component and at least one reactive component with the second material. The at least two density-stratified materials may be immiscible.

In one aspect, a printer for three-dimensional fabrication disclosed herein includes a source of a build material for fabricating an object; a vessel containing a medium selected to change a property of the build material when the object is placed in contact with the medium; a surface within the vessel to receive the object as the object is formed layer by layer using a print head during a fabrication process; a first robotic system operable to control formation of the object by the print head during the fabrication process; and a second robotic system operable to move one or more of the surface, the vessel, and the print head during fabrication of the object to controllably expose the build material to the medium

In one aspect, a printer for three-dimensional fabrication disclosed herein includes a source of a build material for fabricating an object; a build plate to receive the object; an extruder coupled to the source of the build material and movable relative to the build plate, the extruder including a nozzle to deposit the build material during a fabrication process; a first robotic system operable to move the extruder along a build path relative to the build plate to fabricate the object on the build plate based on a computerized model of the object; a vessel containing a medium; one or more heaters in communication with the vessel, the one or more heaters configured to spatially control a predetermined temperature distribution of the medium within the vessel; and a second robotic system operable to move the build plate within the vessel during fabrication of the object to controllably expose the build material to the medium for controlling a temperature of at least a portion of the object during fabrication.

The medium may include a liquid. The predetermined temperature distribution may include a temperature gradient between a top surface of the medium and a bottom surface of the vessel. The predetermined temperature distribution may include a substantially consistent temperature for the medium.

In one aspect, a method disclosed herein includes depositing a build material on a build plate of a printer to fabricate an object based on a computerized model, the build material including a first material and a second material, the first material including a discrete phase for forming a net shape of an object and sinterable into a densified mass, and the second material including one or more binders that resist deformation of the net shape of the object, and moving the build plate within a vessel containing a debinding medium selected to remove at least one of the one or more binders from the object when the object is placed within the debinding medium, wherein the build plate is moved to controllably expose the build material to the debinding medium during fabrication of the object.

The debinding medium may include one or more of a liquid, a gas, and a powder. The method may further include providing the vessel within a build volume of the printer.

In one aspect, a method disclosed herein includes fabricating an object on a surface within a vessel from a build material using a print head, the build material including a first material and a second material, the first material including a discrete phase for forming a net shape of the object and sinterable into a densified mass, and the second material including one or more binders that resist deformation of the net shape of the object, the vessel containing a debinding medium selected to remove at least one of the one or more binders from the object when the object is placed in contact with the debinding medium, and moving one or more of the surface, the vessel, the print head, and a printing plane during fabrication of the object to controllably expose the build material to the debinding medium.

In one aspect, a printer for three-dimensional fabrication disclosed herein includes a source of a build material for fabricating an object, the build material including a first material and a second material, the first material including a discrete phase for forming a net shape of the object and sinterable into a densified mass, and the second material including one or more binders that resist deformation of the net shape of the object; a build plate to receive the object; an extruder coupled to the source of the build material and movable relative to the build plate, the extruder including a nozzle to extrude the build material during a fabrication process; a first robotic system operable to move the extruder along a build path relative to the build plate to fabricate the object on the build plate based on a computerized model of the object; a vessel containing a first medium selected to chemically interact with the build material; and a second robotic system operable to move the build plate within the vessel during fabrication of the object to controllably expose the build material to the first medium.

The first medium may include one or more of a powder, a liquid, a gas, and a plasma. The printer may further include a second medium in the vessel, wherein the second medium is non-chemically reactive with the build material. The first medium may include one or more of an aqueous reaction initiator, a catalyst, a cross linking agent, a solvent, a non-aqueous solvent, water, ethanol, oil, a catalytic debinder, trans-dichloroethylene, limonene, hexane, perchloroethylene, and heptane. The printer may further include a control system to vary a concentration of the first medium during the fabrication process. The vessel may contain at least two density-stratified materials. The at least two density-stratified materials may include at least one inert component and at least one reactive component with the first material. The at least two density-stratified materials may include at least one inert component and at least one reactive component with the second material. The at least two density-stratified materials may be immiscible.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 shows a three-dimensional printing system.

FIG. 2 is a flow chart of a method for three-dimensional fabrication of an object.

### DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately” or the like, when accompanying a numerical value, are to be construed as indicating any deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of the disclosed embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless expressly stated otherwise.

Described herein are devices, systems, and methods for three-dimensionally printing into a vessel containing a liquid medium, e.g., for changing a property of a printed object during a fabrication process. Thus, a method contemplated herein may include fabricating an object and exposing a portion of the object, during fabrication, to a liquid medium contained within a vessel. Similarly, a three-dimensional printer contemplated herein may include a vessel surrounding, or positioned within, a build volume where material is deposited during additive fabrication. For example, in a three-dimensional fabrication process using sinterable materials (e.g., metal injection molding (MIM) materials), a vessel around a build volume may contain a liquid debinding solvent or similar medium that can receive a printed object and initiate debinding during fabrication. A variety of techniques may be used to contain and apply the debinding medium, such as by filling tank around a build volume as an object is formed, or by lowering a build plate into a tank of liquid medium as each new layer of build material is deposited. As a significant advantage, debinding within a build volume during fabrication can substantially reduce overall processing time. Additionally, where the material and solvent systems permit, a top surface of a partially completed object may also be exposed to a debinding solution before a next layer is applied, which can significantly reduce debind times by facilitating deep, early penetration of solvent throughout the volume of a three-dimensional structure.

The liquid medium may also or instead be used for temperature control of the printed part. To this end, the present teachings may include the use of a vessel disposed within the build volume of a three-dimensional printer, where the vessel contains a temperature-controlled medium (e.g., a liquid or a gel) to provide a temperature-controlled environment for at least a portion of a printed object during fabrication thereof—e.g., by moving the printed part into the medium within the vessel during a fabrication process. It will be appreciated that, while the foregoing description emphasizes printing by depositing material into a liquid medium, the present teachings are not so limited, and similar principles may be used to control exposure to gasses (e.g., dense gasses), gels, powders, or other material types that can be contained within a vessel and used to selectively expose exterior surfaces of an object to a medium in an advantageous manner during fabrication.

By way of example, polymeric materials are subject to a range of thermally-induced forces due to thermal expansion/contraction, thermal hysteresis, thermally-induced internal stresses, and so forth, particularly when the material changes temperature frequently and/or rapidly or when an object is exposed to substantial thermal gradients. These thermal effects can manifest as curling, warping, shrinking, delamination, and so forth. To mitigate these thermal effects, a liquid or a gel medium can be used instead of air as a printing environment. As a significant advantage, this can provide substantially higher thermal conductivity and substantially higher heat capacitance, resulting in greater thermal stability and uniformity around a printed object.

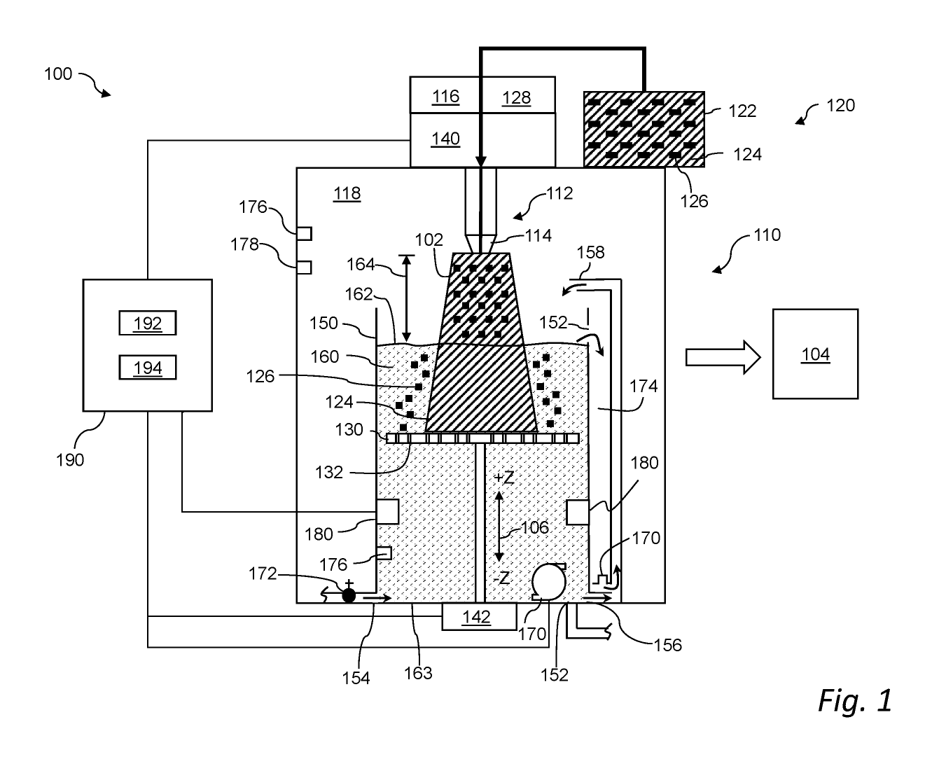

FIG. 1 shows a three-dimensional printing system. The system 100 may generally include a printer 110 for three-dimensional fabrication, a source 120 of a build material 122, a post-processing station 104, a vessel 150, and a controller 190.

The printer 110 may be any three-dimension printer or the like useful for fabricating a net shape of an object using deposition of a build material as contemplated herein. The printer 110 may deposit a build material 122 according to a computerized model to form an object 102, along with any related support structures, interface layers, and so forth. In one aspect, the printer 110 may be used to fabricate an object 102 from a debindable, sinterable build material within a liquid medium 160 or the like in order to initiate debinding during fabrication. However, the system 100 may also or instead be used with other build materials including without limitation plastics, ceramics, and the like, as well as other materials such as interface layers, support structures, and the like that may not sinter to form a final part. For example, a thermoplastic or semisolid material may usefully be deposited layer by layer into a liquid medium to control a thermal gradient within the fabricated object during fabrication.

By way of non-limiting example, the printer 110 may include a fused filament fabrication system, a multijet printer, or any other system that can be usefully adapted to form a net shape object by depositing layers of material under computer control. Thus, while the following description may emphasize three-dimensional printers using fused deposition modeling or similar techniques where a bead of material is extruded in a layered series of two dimensional patterns as “roads,” “paths,” or the like to form a three-dimensional object from a digital model, it will be understood that other additive fabrication techniques are known in the art that may be adapted for use in fabricating an object by material deposition within a vessel of liquid as contemplated herein. All such printing technologies are intended to fall within the scope of this disclosure, and within the scope of terms such as “printer,” “three-dimensional printer,” “fabrication system,” and so forth, unless a more specific meaning is explicitly provided or otherwise clear from the context. Furthermore, other techniques are described herein using, e.g., a powder medium or a gas medium to control a printing environment, and any such techniques for controlling, e.g., a thermal printing environment, the use of a debinding solvent during fabrication, control of surface treatment of an object, and so forth, may also or instead be used with any suitable printing technology without departing from the scope of this disclosure.

Suitable printers for use as the printer 110 are described by way of non-limiting examples in commonly-owned U.S. Pat. No. 9,815,118, the entire content of which is hereby incorporated by reference. The output of the printer 110 may be an object 102 that is initially a green body or the like formed of a build material 122 including any suitable powder (e.g., metal, metal alloy, ceramic, and so forth, as well as combinations of the foregoing), along with one or more binders that retains the powder in a net shape imparted by the printer 110. A wide range of compositions may be employed as the build material 122. For example, powdered metallurgy or Metal Injection Molding (“MIM”) materials or the like may be adapted for use as a build material 122 in a fused filament fabrication process or the like. Some MIM materials with suitable thermo-mechanical properties for extrusion in a fused filament fabrication process are described by way of non-limiting example in Heaney, Donald F., “Handbook of Metal Injection Molding” (2012), the entire content of which is hereby incorporated by reference. However, other powder/binder material systems and the like may also or instead be usefully deposited by an additive fabrication system into a liquid medium as contemplated herein.

The system 100 may include a post-processing station 104 (or stations) where post-printing steps such as debinding, cleaning, sintering, and the like can be performed. It will be noted that, where it is possible or practical to completely debind the object 102 within the medium 160 and/or the vessel 130 as described herein, a separate debinding station may usefully be omitted. In general, the post-processing station 104 may include an oven, sintering furnace, or the like for applying a thermal sintering cycle at a sintering temperature for the build material 122, or the powdered material in the build material 122 in order to sinter the printed object into a densified object. In the context of this description, it will be appreciated that sintering may usefully include different types of sintering. For example, sintering may include the application of heat to sinter an object to full density or nearly full density. In another aspect, sintering may include partial sintering, e.g., for a sintering and infiltration process in which pores of a partially sintered part are filled, e.g., through contact and capillary action, with some other material such as a low melting point metal to increase hardness, increase tensile strength, or otherwise alter or improve properties of a final part. Thus, references to sintering herein should be understood to contemplate sintering and infiltration unless a different meaning is expressly stated or otherwise clear from the context. Similarly, references to a sinterable powder or sinterable build material should be understood to contemplate any sinterable material including powders that can be sintered and infiltrated to form a final part. In one aspect, the post-processing station 104 may be incorporated into the printer 110.

The object 102 may be any object suitable for fabrication using the techniques contemplated herein. This may include functional objects such as machine parts, aesthetic objects such as sculptures, or any other type of objects, as well as combinations of multiple objects that can fit within the physical constraints of the build volume 118, vessel 150, and build plate 130. Some structures such as large bridges and overhangs cannot be fabricated directly using additive manufacturing techniques because there is no underlying physical surface onto which a material can be deposited. In these instances, a support structure may be fabricated, preferably of a soluble or otherwise readily removable material, in order to support a corresponding feature of the object 102. An interface layer may also be fabricated or otherwise formed between the support structure and the object 102 to facilitate separation of the two structures after sintering or other processing.

In general, the printer 110 may include a print head 112 to form the object 102, e.g., layer by layer, in an additive fabrication process. The print head 112 may include an extruder coupled to the source 120 of the build material 122 and movable relative to a surface such as the build plate 130 for fabricating the object 102 on the surface. The extruder may include a nozzle 114 to extrude or otherwise deposit the build material 122 during a fabrication process. Thus, in one aspect, the printer 110 may include a build material 122 that is propelled from a source 120 by a drive system 128 and heated to an extrudable state by a heating system 116, and then extruded through one or more nozzles 114. By concurrently controlling robotics to position the nozzle 114 along an extrusion path relative to a build plate 130 or other surface while extruding, an object 102 may be fabricated on the build plate 130 within a build volume 118.

For a fused deposition modeling device or the like, the nozzle 114 may include an extrusion tip of an extruder. In certain aspects, the nozzle 114 (or the print head 112) may include a plurality of devices for fabrication, and thus the system 100 may include a plurality of nozzles 114 and/or print heads 112. The nozzle 114 may thus include one or more nozzles for extruding build material 122 propelled with the drive system 128 and heated with the heating system 116. While a single nozzle 114 and build material 122 is illustrated, it will be understood that the nozzles 114 may include a number of nozzles that fabricate with different types of material so that, for example, a first nozzle extrudes a sinterable build material while a second nozzle extrudes a support material in order to support bridges, overhangs, and other structural features of the object 102 that would otherwise violate design rules for fabrication with the build material 122, and a third nozzle extrudes an interface material for fabricating separable supports between support structures and the object 102. It will be understood that, because the printer 110 may include different types of fabrication devices as described above, the print head 112 may similarly include different types of print heads 112 suitable for such devices, including without limitation one or more of an extruder, an inkjet head, a light-emitting device, and a laser.

The heating system 116 may employ a variety of techniques to heat a build material 122 to a temperature within a working temperature range where the build material 122 has suitable rheological properties for extrusion in a fused filament fabrication process, or otherwise for fabrication with a printer 110 as described herein. This working temperature range may vary according to the type of build material 122 being used, e.g., the constituent first material 124 (e.g., a powder or other discrete phase material) and second material 126 (e.g., a binder system, which may be a continuous phase material, a mixture of discrete and continuous phases, or some combination of these) described below. The heating system 116 may include any heating system or combination of heating systems suitable for maintaining the build material 122 at a corresponding working temperature range as needed for extrusion.

In general, the build volume 118 may house the build plate 130 and the vessel 150. The build volume 118 may maintain a build environment suitable for fabricating the object 102 from the build material 122. Where appropriate for the build material 122 or contents of the vessel 150, this may include a vacuum environment, an oxygen depleted environment, a heated environment, an inert gas environment, and so forth. The build volume 118 may also form a chamber suitable for containing any of the components of the printer 110 used within the build volume 118 to fabricate the object 102.

The source 120 of the build material 122 may include a spool, a cartridge, a vat, or any container(s) suitable for containing the build material 122 and supplying the build material 122 to the printer 110. The source 120 of the build material 122 may be incorporated into the printer 110, or the source 120 may be a separate component from the printer 110.

The build material 122 may be any material suitable for the fabrication of an object 102 as contemplated herein, and may be provided in a variety of form factors. The build material 122 may be provided, for example, from a hermetically sealed container or the like (e.g., to mitigate passivation), as a continuous feed (e.g., a wire on a spool or the like), or as discrete objects such as rods or rectangular prisms that can be fed into a chamber or the like as each prior discrete unit of build material 122 is heated and extruded. The build material 122 may also or instead be provided in pellet or particulate form for heating and compression. More generally, any geometry that might be suitably employed for heating and extrusion might be used as a form factor for a build material 122 as contemplated herein. In one aspect, the build material 122 may be formed of a number of different materials. For example, a build material 122 for fabricating sinterable objects may include at least a first material 124 such as a discrete phase for forming a net shape of the object and sinterable into a densified mass, and a second material 126 such as one or more binders that resist deformation of the net shape of the object 102, i.e., during or after extrusion of the build material 122.

The first material 124 may include a sinterable build material such as a metal powder loaded into a binder system of the second material 126 for heating and extruding using the techniques contemplated herein. More generally, the first material 124 may include any suitable material such as a discrete phase material, a combination of continuous and discrete phase materials, and so forth, any of which may be loaded into a binder system of the second material 126 for heating and extruding using the techniques contemplated herein. It will be understood that a discrete phase as described herein may include one or more of powders, particles, fibers, discrete phases of polymer blends, droplets, and so on, as well as any combination of the foregoing. A discrete phase material, as contemplated herein, may be differentiated from a continuous phase material based on the presence or absence of contact or boundaries between individual moieties of the discrete phase. By contrast, a continuous phase may include a material that is connected and/or homogenous throughout. For example, a liquid or polymer binder or the like can provide a continuous matrix for individual pieces of a discrete phase build material, and the discrete phase pieces may be separated by, and distributed throughout, the continuous phase. Thus, a discrete phase may include any component that is unconnected from the other discrete and continuous objects (excluding contact) included therein, and may include (but is not limited to) any solid particles, fibers, or the like.

It will be appreciated that the distinction between discrete and continuous phases may depend at times on the scale (e.g., microscopic v. macroscopic) of the representative volume in which the phase is observed. However, terms such as ‘discrete’ and ‘continuous’ are well understood in, e.g., colloidal science, and they can be readily distinguished by one of ordinary skill in the art based on macrostructures, microstructures, particle size and distribution, and/or the transport properties of the respective phases within an emulsion. In one aspect, emulsions such as polymer blends may include both phases, e.g., where one or more types of polymers form droplets within other types of polymers. Even if the polymers in the droplet phase are liquid at ambient conditions, or are otherwise relatively soft, they may still be considered a discrete phase in such an emulsion where each droplet is separated by the accompanying, continuous phase medium.

In one aspect, the first material 124 may be formed of any powder metallurgy material or other metal or ceramic powder(s) suitable for sintering. The powdered material may be densified into a final part through sintering. The first material 124 (and/or second material 126) may also or instead be configured for processes other than sintering such as infiltration and thermally-activated pyrolysis of a polymer-derived ceramic.

The second material 126 may generally be used to impart rheological properties suitable for extrusion into a controlled net shape. For example, this may include one or more materials selected to render the composition flowable for extrusion, which may be removed through any of a variety of debinding processes. The second material 126 may be formed of a wax, a thermoplastic, a polymer, or any other suitable material, as well as combinations of the foregoing. Thus, the second material 126 may generally be combined with the first material 124 (e.g., a powdered build material) to provide a structural matrix that is suitable for deposition (e.g., in a fused filament fabrication process), and that will support a fabricated net shape up until at least the beginning of a thermal sintering cycle. In contemporary MIM materials, the binding system may include multiple binders that can be generally classified as bulk binders and backbone binders (also referred to as primary and secondary binders). The bulk binders can flow at elevated temperatures, and retain the shape of an object 102 after an initial build in normal atmospheric conditions. The backbone binder will provide binding later into the sintering process and helps retain the shape as the thermal sintering cycle begins but before substantial sintered strength has been achieved. The backbone binder(s) will be the last to gas off during a sintering process. The binder(s) may vary according to the build material 122 and the intended application. For example, the binder may be formed of polymers with a lower glass transition temperature or less viscosity for higher-resolution printing. The second material 126 may also or instead include other additives. For example, the second material 126 may incorporate a getter for oxygen or other contaminants. As another example, the second material 126 may include a liquid phase or other surface-active additive to accelerate the sintering process.

The second material 126 may include a cross-linkable material, and the medium 160 in the vessel 150 may include an agent that promotes cross linking, or alternatively, an agent that prevents cross linking during printing so that improved bonding can occur (and where cross linking can occur at a later time). An example of a cross linking reaction that may be suitable for a system 100 such as that shown in FIG. 1 includes a polyester resin based binder being printed into a medium 160 containing an initializer (typically a peroxide, and sometimes referred to as a “catalyzing agent”) that initiates solidification of the resin into a cross linked thermoset material suitable for binding powder particles for future debinding and sintering.

The system 100 of FIG. 1 may also or instead include any combination of materials that produce a desired result. Such combinations may be arranged in stratified layers. For example, there may be a multi-component combination in which the printed material is applied and exposed to an initial material, perhaps a first top layer of the medium 160 or a gas, then another layer that results in another desired reaction or interaction. For example, a layered medium 160 may be used when printing a polyester mixed with a metal power. That is, a system 100 may include printing into a bath that contains a top layer that covers the nozzle 114 to prevent evaporation of volatile resin components, such as styrene in the resin, and/or prevents evaporation of the underlying initiator layer which might be a hazardous material such as methyl ethyl ketone peroxide. These two layers may, in turn, sit on top of another layer of a composition that produces improved properties, for example, sealing against air, which can improve the curing of the resin. Under that layer may lie a bath that performs some aspect of a debinding process, such as a first stage debind. It is of course possible that the printing is performed “upside-down” so that the print rises from the liquid bath where it experiences a gas environment, or that the print is performed “sideways” or at an angle such that the desired interactions occur at an appropriate time and place, e.g., given the relevant densities of the materials involved.

In this manner, the vessel 150 may contain a medium 160 that is selected to chemically interact with the build material 122, and a second robotic system 142 operable to move the build plate 130 within the vessel 150 during fabrication of the object 102 to controllably expose the build material 122 to this chemically-interacting medium 160. Moreover, the vessel 150 may contain a plurality of mediums 160, e.g., a first medium that is chemically interactive with the build material 122 and a second medium that is non-chemically reactive with the build material 122. Such a first medium may include one or more of a powder, a liquid, a gas, and a plasma. In some implementations, the first medium includes one or more of an aqueous reaction initiator (e.g., a peroxide for polyester), a catalyst, a cross linking agent, a solvent, a non-aqueous solvent, water, ethanol, oil, a catalytic debinder, trans-dichloroethylene, limonene, hexane, perchloroethylene, heptane, and so on.

The medium 160 may also or instead include at least two density-stratified materials. For example, in certain implementations, the medium 160 contains density-stratified materials including at least one inert component that is non-reactive with the build material 122 and at least one reactive component that reacts with the build material 122 (or components of the build material 122). For example, the density-stratified materials may include at least one inert component that does not react with the first material 124 and at least one reactive component that reacts with the first material 124. The density-stratified materials may also or instead include at least one inert component that does not react with the second material 126 and at least one reactive component that reacts with the second material 126. Such density-stratified materials may be immiscible so that a boundary is established between the two, and regions of an object 102 can be selectively exposed to the reactive or inert components based on a relative volume of the two (or more) density-stratified materials and the position of the object 102 within the medium 160 (or more specifically, the position of the object 102 relative to a plane formed by the boundary between the reactive and inert components). In another aspect, the density-stratified materials may be soluble with one another to provide a continuous gradient of reactivity for an object 102 immersed within the medium 160.

Any suitable MIM materials, or any other composition containing a base of powdered, sinterable material in a binder system may be used as a build material 122 as contemplated herein. More generally, any powder and binder system forming a sinterable build material with rheological properties suitable for fused filament fabrication may be used in an additive fabrication process as contemplated herein. Such a build material may generally include a powdered material such as a metallic or ceramic powder for forming a final part, along with a binder system to impart suitable rheological properties and retain a net shape during processing into a final object. As discussed above, the processing may include, e.g., debinding the net shape to remove at least a portion of the one or more binders and sintering the net shape to join and densify the powdered material. While powdered metallurgy materials are discussed herein, other powder and binder systems may also or instead be employed in a fused filament fabrication process. Still more generally, it should also be appreciated that other material systems may be suitable for fabricating sinterable net shapes using fabrication techniques such as three-dimensional jet printing or the like.

The drive system 128 may include any suitable gears, compression pistons, or the like for continuous or indexed feeding of the build material 122 into the print head 112 or heating system 116. The build plate 130 may include a surface suitable for receiving deposited build material 122 from the print head 112. The surface of the build plate 130 may be rigid and substantially planar. In one aspect, the build plate 130 may be heated, e.g., resistively or inductively, to control a temperature of the build volume 118 or a surface upon which the object 102 is being fabricated. This may, for example, improve adhesion, prevent thermally induced deformation or failure, and facilitate relaxation of stresses within the object 102. In another aspect, the build plate 130 may be a deformable structure or surface that can bend or otherwise physically deform in order to detach from a rigid object 102 formed thereon. The build plate 130 may be fixed or movable within the build volume 118. For example, the build plate 130 may be movable within the vessel 150 included within the build volume 118. This movement may be facilitated by a robotic system as described below or otherwise known in the art.

The build plate 130 may be porous, e.g., to allow the medium 160 to pass through the build plate 130 as the build plate 130 moves along the z-axis 106 within the vessel 150 or relative to a top surface 162 of the medium 160. For example, the build plate 130 may include one or more fluid channels 132 to expose a bottom surface of the object 102 adjacent to the build plate 130 to the medium 160 (e.g., a debinding solvent) in the vessel 150. More generally, the build plate 130 may include a mesh screen, through holes, or other fluid passages from a top surface to a bottom surface (or side surfaces) to permit or facilitate exposure of a bottom surface of the object 102 to the medium 160. The build plate 130 may also or instead be constructed of a material that is permeable to the medium 160 (and optionally the binder), so that the medium 160 can diffuse or otherwise pass through the build plate 130 to permeate the object 102 and carry binder (e.g., the second material 126) from the build material 122 of the object 102 into the liquid in the vessel 150.

It will be appreciated that the system 100 described herein contemplates three independent planes of operation: the print plane where the print head 112 deposits material to form the object 102, a build plate plane through the build plate 130, and a liquid surface plane through the top surface 162 of the medium 160. These planes may be independently and/or cooperatively controlled in any suitable manner to control exposure of the object 102 to the medium 160, e.g., to optimize or regulate a dual fabrication and debinding process. In one aspect, the system 100 may include a first robotic system 140 operable to move the print head 112 (e.g., the nozzle 114) along a build path, e.g., in an x-y plane relative to the build plate 130 to fabricate the object 102 on the build plate 130 based on a computerized model of the object 102. The system 100 or printer 110 may further include a second robotic system 142 operable to move the build plate 130 (or other surface) within the vessel 150 during fabrication of the object 102 to controllably expose the build material 122 to a medium 160 (e.g., a debinding liquid) contained therein, and to control a z-axis position of the print head 112 (e.g., the nozzle 114) relative to the build plate 130 and/or object 102. More generally, any combination of robotic systems and components suitable for effecting controlled, relative movement of the build plate 130, the print head 112, and/or a level of the medium 160 within the vessel 130 may be employed as robotic systems as contemplated herein.

A variety of robotics systems are known in the art and suitable for use as the first robotic system 140 contemplated herein. For example, the first robotic system 140 may include a Cartesian coordinate robot or x-y-z robotic system employing a number of linear controls to move independently in the x-axis, the y-axis, and the z-axis 106 within the build volume 118. Delta robots may also or instead be usefully employed, and such robots can, if properly configured, provide significant advantages in terms of speed and stiffness, as well as offering the design convenience of fixed motors or drive elements. Other configurations such as double or triple delta robots can increase range of motion using multiple linkages. More generally, any robotics suitable for controlled positioning of a print head 112 relative to the build plate 130 may be usefully employed, including any mechanism or combination of mechanisms suitable for actuation, manipulation, locomotion, and the like within the build volume 118.

The second robotic system 142 may be operable to move the build plate 130 and a top surface 162 of the medium 160 in the vessel 150 relative to one another during fabrication of the object 102. For example, the second robotic system 142 may be operable to move the build plate 130 along the z-axis 106 during fabrication of the object 102, while the first robotic system 140 moves the print head 112 (or a component thereof) along a build path within an x-y plane, or the second robotic system 142 may be operable to control a level of the medium 160 or a position of the vessel 150 relative to the object 102, build plate 130, and/or print head 112. In general, the second robotic system 142 may include any of the robotics described herein for moving one or more of the build plate 130, the vessel 150 (or contents thereof), and the print head 112, and/or any of the pumps or other fluid management components described herein. The first robotic system 140 and the second robotic system 142 may be a single, integrated robotic system, or the first robotic system 140 and the second robotic system 142 may be different, independent systems.

Where a liquid medium is used within the vessel 150, movements of the print head 112 may cause disturbances at a top surface 162 of the medium 160 (or otherwise in the medium 160). To mitigate these disturbances, the second robotic system 142 or the first robotic system 140 may employ smoothing when acceleration or decelerating from a stationary position. In another aspect, x-y movements of the print head 112 may be performed above the top surface 162 of the medium 160, or may be performed at a rate (e.g., relatively slow) selected to minimize surface disturbances.

The vessel 150 may contain a medium 160 selected to change a property of the build material 122 when the object 102 is placed in contact with the medium 160. While a liquid medium for debinding or thermal control is expressly contemplated, it will be appreciated that other adaptations of these techniques are possible, and the medium 160 may usefully contain one or more of a liquid, a gas, and a powder. The medium 160 may also be selected for functions different from, or additional to, debinding and thermal control. For example, the medium 160 change a property of the build material 122 such as a color and a texture. The medium 160 may also or instead be selected to remove at least a portion of the build material 122 of the object 102 (including, or in addition to, a binder system) when the object 102 is placed in contact with the medium 160. In one useful embodiment, the build material 122 may include a first material 124 including a powder for forming a net shape of the object 102 and sinterable into a densified mass and a second material 126 including one or more binders that resist deformation of the net shape of the object 102, i.e., during or after extrusion of the build material 122, and the medium 160 may include a debinding liquid selected to remove at least one of the binders of the second material 126 from the object 102. Thus, the medium 160 may include a debinding medium, such as a debinding liquid. The medium 160 may also or instead be selected to treat support or interface layers of the object 102 when the object 102 is placed in contact with the medium 160, e.g., by embrittlement, softening, or otherwise treating the corresponding materials to facilitate subsequent processing.

The vessel 150 may further include heating systems, circulation systems, and the like to control the medium 160 in a manner that promotes debinding, facilitates heat transfer, or otherwise usefully controls the printing environment.

The vessel 150 may be sized and shaped such that the build plate 130 fits inside the vessel 150, thereby allowing the printed object 102 to come into contact with, and be submerged in, the medium 160, e.g., by moving the build plate 130 into an interior of the vessel 150. The vessel 150 may also or instead be sized and shaped to accommodate additional mediums 160, e.g., one or more of liquids, gels, powders, gases, and so on. For example, the vessel 150 may be insulated, covered, sealed (e.g., hermetically sealed), pressurized, and so forth in order to maintain a second (e.g., different density) fluid or a gas above a first liquid medium. The vessel 150, or the medium 160, may also or instead be configured to mitigate or promote evaporation of the medium 160, or the effects from evaporation of the medium 160.

In some implementations, submersion of the object 102 occurs by moving the build plate 130 with the second robotic system 142 relative to the top surface 162 of the medium 160, such that the object 102 mechanically drops into the medium 160 during a build. To accommodate the resulting displacement in volume of the medium 160, the vessel 150 may include one or more drains 152, which may be positioned, for example, at a desired z-axis position of a top level of the medium 160 so that the medium 160 can passively maintain a fixed z-axis level as the object 102 and build plate 130 descend into the vessel 150 displacing the liquid. The top surface 162 of the medium 160 may also or instead be adjusted by the addition or discharge of media, e.g., by one or more of an inlet 154, an outlet 156, and a spout 158. The drain 152 may also or instead be used for other purposes, such as removing, recycling, or recirculating the medium 160. The one or more drains 152 in the vessel 150 may, for example, include an overflow drain, a bottom drain, or another type of drain for removing liquid from the vessel 150.

The top surface 162 of the medium 160 may usefully be maintained at a predetermined distance 164 (along the z-axis 106) relative to a top of the object 102, or a predetermined distance 164 from a bottom of the print head 112, or at some other fixed or variable z-axis position. In some implementations, the print deposition process may occur above the top surface 162 of the medium 160. In other implementations, the print deposition process may be at about the top surface 162 of the medium 160, or just above the top surface 162 of the medium 160. In another aspect, the print deposition may occur at or slightly below the top surface 162 of the medium 160. Thus, the medium 160 may generally be maintained at a level just above, about at, or just below the current print level at which material is being deposited. Where the print process occurs partially or wholly below the top surface 162 of the medium 160, the print head 112 may be adapted to be submerged in the medium 160.

In another aspect, the current fabrication layer may variably move above and below the top surface 162 of the medium. For example, a layer of build material 122 may be deposited at a height above the top surface 162 of the medium 160, and the object 102 may then be lowered (or the fluid level raised) in order to coat a top surface of the object 102, after which the object 102 may be raised again (or the fluid level lowered) in order to expose the coated top surface of the object 102 for deposition of another layer of build material 122. This technique may advantageously be employed to expose intermediate layers of the object to a debinding solvent or other medium in order to initiate debinding, control temperature, deposit supplemental materials, or otherwise treat the build material 122 within interior regions of the object 102. With a suitable medium 160, this technique may also or instead be used to solubilize an exposed layer of the object 102 for improved adhesion with a second layer deposited thereon.

In one aspect, the build plate 130 may remain at a fixed z-height during fabrication. For example, fabrication on the build plate 130 may begin in an empty vessel 150 (or above the top surface 162 of the medium 160 within the vessel 150), and the vessel 150 may be filled thereafter by actively adding liquid to the vessel 150. In this manner, the build plate 130 need not move along the z-axis 106 to submerge a portion of the object 102. Instead, the top surface 162 of the medium 160 may be increased in coordination with the printing of the object 102 by filling the vessel 150 with the medium 160. In another aspect, the object 102 may be fabricated in its entirety in a substantially empty vessel 150, where the vessel 150 is filled with the medium 160 to submerge the object 102 after fabrication of the object 102 (or a portion thereof). Thus, in one aspect, there is disclosed herein a printer 110 including a liquid-carrying vessel 150 containing a build platform 130 and disposed around a build volume 118. The vessel 150 may be a removable vessel that can be transported from the printer 110, with the object 102 therein, to another processing station for further debinding, rinsing, sintering, and so forth.

Where the fluid level is actively controlled, the system 100 may include a level control system to maintain a predetermined position of a top surface 162 of contents within the vessel 150 relative to the build plate 130, the print head 112, and/or the object 102. The level control system may include one or more of a drain 152, an inlet 154, an outlet 156, a spout 158, a pump 170, one or more valves 172, an overflow vat 174, and a controller 190. Further, one or more of the aforementioned components may also or instead be part of a circulation system for the vessel 150, which may be used, for example, to advantageously control fabrication, e.g., by promoting faster debinding, maintaining uniform thermal conditions, and so forth. The circulation system, e.g., a pump 170 and associated piping, may be operable to move the medium 160 within the vessel 150, into and out of the vessel 150, between the vessel 150 and the spout 158, and so on.

Each of the inlet 154 and the outlet 156 of the vessel 150 may be in fluid communication with other components and structurally configured to circulate the medium 160 into and out of the vessel 150. Associated piping, along with one or more pumps 170, valves 172, and so forth may be used to manage fluid distribution within the system 100. One or more sensors 176 may be included, and may be used by the controller 190 to monitor the height or flow of the medium 160 in order to provide feedback control over filling, concentration, temperature, height, fluid recirculation, and so forth. Also, or instead, the medium 160 may be continuously pumped into or through the vessel 150, e.g., using one or more of the spout 158, the drain 152 (e.g., an overflow), the overflow vat 174, and so on. This may be useful, for example, to maintain a uniform temperature, to remove and replace solvent that is carrying binder components, and so on.

The spout 158 may be operable to spray or otherwise disperse the medium 160 (e.g., a liquid, such as a debinding liquid) into the vessel 150. The medium 160 may, for example, be sprayed directly onto the object 102, or the medium 160 may be dispersed into the vessel 150 without contacting the object 102. Thus, in some aspects, e.g., where exposure of a top surface of the object 102 to the medium 160 is desired, the object 102 may be sprayed with the medium 160 instead of, or in addition to, being submerged in the medium 160 within the vessel 150.

The pump 170 may be in fluid communication with the vessel 150, and operable via the controller 190 to move the medium 160 into or out of the vessel 150. The pump 170 may be disposed in the vessel 150 or within piping connected to the vessel 150. In one aspect, the pump 170 may include an inlet and an outlet within the vessel 150, and may be generally operable to promote continuous fluid movement by circulating the medium 150 within the vessel 150.

The pump 170 may be responsive to feedback from the one or more sensors 176. For example, the pump 170 may be responsive to a sensed temperature to maintain a predetermined temperature distribution within the vessel 150. The pump 170 may also or instead be responsive to a sensed height of the top surface 162 within the vessel 150, a sensed position of the build plate 130 and/or a top surface of the object 102, a sensed position of the print head 112 relative to the top surface 162 of the medium 160, a local concentration of the second material 126 within the medium 160, or any other condition or combination of parameters useful for controlling conditions of the medium 160 and a fabrication process occurring in the system 100.

The valves 172 may be any suitable valves known in the art, including without limitation solenoid valves or other electrically, magnetically, and/or mechanically controlled valves that are operable via the controller 190.

The overflow vat 174 may disposed about at least a portion of the vessel 150. The overflow vat 174 may be structurally configured, for example, to capture any portion of the medium 160 that is discharged via the overflow drain or the like. A second pump 170 may be provided to return displaced medium 160 from the overflow vat 174 back into the vessel 150, e.g., via the spout 158. The displaced medium 160 may also or instead be returned to the vessel 150 using any another suitable techniques, or discarded as appropriate.

The sensors 176 may include without limitation one or more of a temperature sensor, a flow sensor (e.g., a volume flow rate sensor), a motion sensor, a concentration sensor, a viscosity sensor, a density sensor, a force sensor, a level sensor, a weight sensor, a sound sensor, a light sensor, a sensor to detect a presence (or absence) of an object, a contact profilometer, a non-contact profilometer, an optical sensor, a laser, an imaging device, a camera, an encoder, an infrared detector, and so on. The sensor 176 may generally provide feedback to the controller 190 for controlling operation of one or more of the components of the system 100, such as for controlling the temperature, concentration, or physical distribution of the medium 160 within the vessel 150 and/or relative to the object 102 and/or print head 112. The sensors 176 may also or instead be used to monitor fabrication of the object 102.

The medium 160 may include a debinding medium such as a debinding solvent. In one aspect, e.g., where at least one of the binders of the second material 126 is removed by exposure to water, the debinding medium may include water. The debinding medium may also or instead include one or more of a gaseous nitric acid, a gaseous oxalic acid, an aqueous solvent, a non-aqueous solvent, ethanol, oil, a supercritical fluid (e.g., carbon dioxide), a catalytic debinder, trans-dichloroethylene, limonene, hexane, perchloroethylene, heptane, and so on. Thus, the medium 160 may be selected to dissolve or otherwise remove a primary binder included in the build material 122. For example, in wax-polymer systems, trans-dichloroethylene and substances based upon trans-dichloroethylene, limonene, hexane, perchloroethylene, heptane, other aliphatic liquids (e.g., mineral oil) may be used as a debinding medium. In water-debinding systems (e.g., those with polyethylene glycol (PEG) as a primary binder), water or ethanol may be used as a debinding medium.

The medium 160 may also or instead include a gaseous medium. For example, the vessel 150 may include a substantially sealed chamber filled with nitric acid vapors heated to about 100-150 degrees Celsius to accomplish catalytic debinding during printing. In this manner, debinding may be accomplished relatively quickly, and swelling may be mitigated for better accuracy of printed parts. Other gaseous mediums are also or instead possible.

The medium 160 may also or instead a supercritical fluid, e.g., for debinding using supercritical carbon-dioxide. For accommodating such a medium 160, the vessel 150 may be pressurized. Pressurizing the vessel 150 may also or instead be used to control physical properties of a gas. For example, heat capacity and thermal conductivity of a gas typically rises with increasing pressure, which can improve thermal control of a printing process when operating in a gaseous fluid.

The medium 160 may also or instead include a thermally conductive fluid used to promote a uniform temperature distribution about a surface of the object 102. In this capacity, a fluid such as water or the like may be used. A suitable oil may also or instead be employed to promote heat transfer while minimizing corrosive effects on metallic build materials. Thus, for thermal control, the medium 160 in the vessel 150 may also or instead be selected as a function of the build material 122. In another aspect, the medium 160 may advantageously be selected to promote concurrent debinding and thermal control.

In one aspect, the medium 160 may include a powder. For example, the medium 160 may include a debinding medium at least partially containing a powder, where at least one of the binders of the second material 126 is removed by wicking into the powder. The powder contained within the medium 160 may include without limitation one or more of a ceramic, alumina, and the like. In one aspect, e.g., for fused filament fabrication, the powder may be spread up to, but not above, a current print level so that the powder does not interfere with layer-to-layer bonding. The system 100 may thus also include one or more powder devices 178 for applying or removing powder from the object 102, e.g., for coating powder onto the object 102 during fabrication. In certain aspects, the spout 158 discussed above may be used to apply powder to the object 102. The powder devices 178 may also or instead include one or more of a blower operable to provide a burst of gas to remove at least some of the powder after coating, and an agitator operable to create an agitated flow of the powder for applying to the object 102.

The vessel 150 may include a plurality of different mediums 160, or the medium 160 may include a plurality of different compositions and/or phases. By way of example, the vessel 150 may include a debinding liquid as a first medium, along with a second medium having different properties, e.g., a different density, a different viscosity, a different thermal conductivity or heat capacity, a different phase, a different miscibility, and so forth. In another aspect, the vessel 150 can be filled with a medium 160 such as a liquid, e.g., a single liquid or multiple liquids. In the case of multiple liquids, multiple layers may be created based on the density of the liquids. Various layers/liquids can serve different purposes including heat retention, solvent evaporation prevention, improved solubility, stability for printed features, and so on. More generally, the medium 160 may contain any combination of compositions, materials, phases, and the like suitable for controlling an additive fabrication process as contemplated herein.

The system 100 may include one or more heaters 180 for controlling a temperature or temperature distribution of the medium 160. For example, the printer 110 may include a heater 180 in communication with the vessel 150 to maintain a predetermined temperature within the vessel 150. The predetermined temperature may include a plurality of temperatures, e.g., a temperature gradient between a top surface 162 of contents of the vessel 150 and a bottom surface 163 of the vessel 150. The predetermined temperature may also or instead include a substantially consistent temperature for the contents of the vessel 150. In one aspect, the system 100 may include a plurality of heaters 180 configured to spatially and temporally control a temperature distribution of the medium 160 within the vessel 150. The one or more heaters 180 may be used in cooperation with the fluid circulation components described above to actively promote more uniform thermal conditions within the vessel 150, e.g., around a surface of the object 102, or more generally to control a temperature distribution within the vessel 150.

The heater(s) 180 may be disposed within the vessel 150 or external to the vessel 150. In one aspect, the medium 160 may be heated prior to pumping into the vessel 150. The medium 160 may also or instead be heated while within the vessel 150. It may be useful to maintain the medium 160 at a homogenous or otherwise spatially controlled temperature throughout the vessel 150. A uniform temperature may be promoted, for example, by controlling a temperature of the medium 160 as it is introduced into the vessel 150, and/or by actively and continuously circulating the medium 160 within the vessel 150. For heterogeneous temperature distributions, the system 100 may usefully include multiple heaters 180, sensors 176, and pumps 170 which may be variously arranged and controlled to achieve desired temperature profiles. While a uniform temperature may mitigate thermally induced stress and defects, temperature variations may also be useful in a variety of contexts. For example, temperature may be used to control dissolution rates, chemical activity rates, mechanical properties of the build material 122 (e.g., softness or pliability), and so forth.

The heater(s) 180 may also or instead be used as part of a temperature control system for the build volume 118 outside of the liquid contents of the vessel 150. For example, the temperature control system may include a coolant, a fan, a blower, or the like, which may be used alone or in combination to circulate air within the build volume 118 to control an ambient temperature, to provide a more uniform surface temperature, or to transfer heat within the build volume 118, e.g., to and from the medium 160. While heaters 180 are generally described, it will be understood that cooling may also or instead be useful in certain thermal control applications. Thus, the heaters 180 may more generally include any thermal control devices such as resistive heaters, inductive heaters, infrared sources, Peltier effect devices that heat or cool in response to an applied current, fluid coolant systems, or any other thermoelectric heating and/or cooling devices. Thus, the temperature control systems discussed herein may include a heater 180 that provides active heating to the medium 160, vessel 150, printer 110, or ambient environment, as well as one or more cooling elements, or any combination of these. The temperature control systems may be coupled in a communicating relationship with the controller 190 in order for the controller 190 to controllably impart heat to, or remove heat from, the components of the printer 110, the medium 160, the object 102, and so forth. It will be further understood that all temperature control systems may be included in a singular temperature control system (e.g., included as part of an overall control system) or they may be separate and independent temperature control systems. Thus, for example, a heated build plate 130, a heated nozzle 114, or a heated vessel 150 may contribute to heating of the build volume 118, the medium 160, and/or the object, and thus form a component of a temperature control system for the system 100.

The system 100 may include a controller 190, which may generally control operation of the printer 110 and/or other components of the system 100. The controller 190 may, for example, include a processor 192 and a memory 194 configured, e.g., by computer executable code stored in the memory 194 and executable by the processor 192, to control fabrication processes, thermal processes, fluid control processes, and other system functions contemplated herein. In one aspect, the controller 190 may be configured to control or operate one or more of the components of the system 100 such as the printer 110, the build plate 130, the robotic systems, the spout 158, the pumps 170, the valves 172, the sensors 176, the heaters 180, and so on. For example, in an aspect, the processor 192 may be configured by computer executable code to move the first robotic system 140 and the second robotic system 142 in order to control a build path of the print head 112 relative to the build plate 130 and fabricate the object 102. The controller 190 may also or instead control a fluid level, fluid temperature, or other properties of the medium 160 as generally described herein.

The controller 190 may more generally include any combination of software and/or processing circuitry suitable for controlling the various components of the system 100 described herein including without limitation microprocessors, microcontrollers, application-specific integrated circuits, programmable gate arrays, co-processors, signal processors, digital-to-analog or analog-to-digital converters, and other processing circuitry or any other digital and/or analog components, as well as combinations of the foregoing, along with inputs and outputs for transceiving control signals, drive signals, power signals, sensor signals, and the like. In one aspect, the controller 190 may include a microprocessor or other processing circuitry with sufficient computational power to provide related functions such as executing an operating system, providing a graphical user interface (e.g., to a display coupled to the controller 190 or printer 110), converting three-dimensional models into tool instructions or other machine-ready code, and operating a web server for the printer 110 or otherwise hosting remote users and/or activity through a network interface coupled in a communicating relationship with a data network. In order to control operation of the printer 110, the controller 190 may be coupled in a communicating relationship with any instrumentation or components associated with the system 100 or build process.

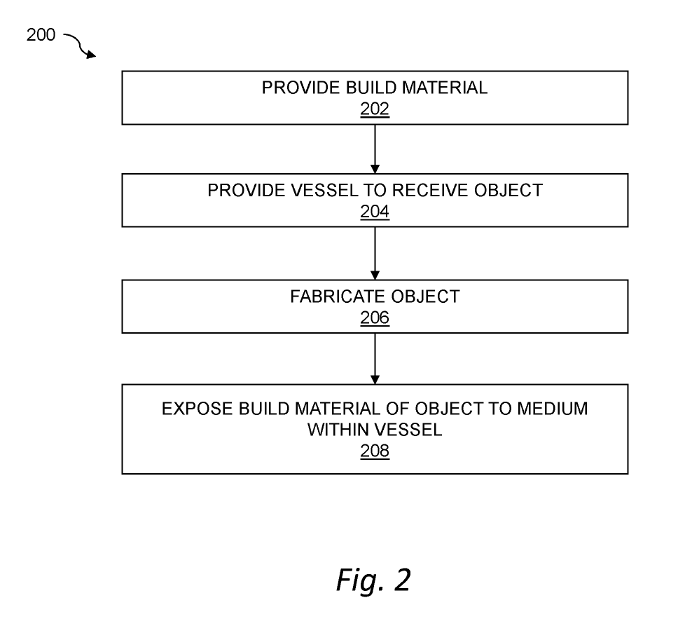

FIG. 2 is a flow chart of a method for three-dimensional fabrication of an object. The method 200 may be performed using any of the fabrication tools discussed herein, e.g., the system 100 and printer 110 of FIG. 1.

As shown in step 202, the method 200 may include providing a build material from a source. The build material may be any of the build materials described herein for fabricating a three-dimensional object with a printer, and the source may include any of the build material sources described herein. For example, the build material may include a first material and a second material, where the first material includes a powder for forming a net shape of an object that is sinterable into a densified mass, and where the second material includes one or more binders that resist deformation of the net shape of the object during fabrication (and where appropriate, any post-printing steps) with the build material. Thus, the build material may be configured or selected for use in an extrusion process or the like to form a three-dimensional object that can be subsequently processed by debinding and sintering into a final part.

As shown in step 204, the method 200 may include providing a vessel to receive a fabricated object. The vessel may be any of the vessels described herein, and may, for example, contain a liquid such as a debinding medium selected to remove at least one of the binders of the build material. Thus, when the build material is deposited to form an object on the build plate within the vessel, debinding of the object may begin in situ as the object is being fabricated by exposing the object to the debinding medium, such as by adding debinding medium to bring a level of the debinding medium within the vessel up to a level of the object (or more specifically, at or near a top surface of the object), or by lowering the object into the debinding medium within the vessel. While a liquid debinding medium may usefully be employed with a vessel within a printer as contemplated herein, it will be understood that in other embodiments, the debinding medium may include a liquid, a gas, a powder, or combinations of these.

As shown in step 206, the method 200 may include fabricating on object based on a computerized model, such as by depositing the build material on a build plate of the printer in a pattern based on a computerized model of the object, or otherwise fabricating the object on a surface within the vessel. As described herein, the printer may include a fused deposition modeling device with an extruder as a print head, or any other suitable printer or the like for depositing build material in an additive fabrication process.

As shown in step 208, the method 200 may include exposing the build material to the medium within the vessel, such as by moving the build plate within the vessel or by controlling a level or amount of the medium within the vessel. More generally, any technique for moving one or more of the relevant surfaces—a top surface of the medium, a surface of the build plate holding the object, the vessel containing the medium, the print head that deposits the build material, and a printing plane in which deposition occurs—alone or relative to one another during fabrication of the object may be employed to controllably expose the build material to the medium as contemplated herein. In this manner, the build material can be controllably exposed, for example, to a medium such as a debinding medium in the vessel to initiate debinding during a print process. Exposing the build material to the medium may also or instead change another property of the build material of the object, control a temperature of the object, or otherwise control or modify the object during fabrication.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

1.-29. (canceled)

30. A printer system for the fabrication of a three-dimensional object, comprising:
a build plate;
a nozzle movable relative to the build plate and configured to deposit a plurality of successive layers of build material according to a computerized model of the object, the build material including a binder and sinterable particles;
a vessel containing a debinding liquid; and
a robotic system configured to move the build plate within the vessel during the depositing of the successive layers such that the deposited build material contacts the debinding liquid.

31. The printer of claim 31, further comprising a heater in communication with the vessel to maintain a predetermined temperature within the vessel.

32. The printer of claim 31, further comprising a level control system configured to maintain a predetermined position of a top surface of the debinding liquid.

33. The printer of claim 31, further comprising an overflow vat configured to receive overflow debinding liquid from the vessel via an overflow drain.

34. The printer of claim 31, wherein the debinding liquid includes one or more of an aqueous solvent, a non-aqueous solvent, water, ethanol, oil, a catalytic debinder, trans-dichloroethylene, limonene, hexane, perchloroethylene, and heptane.

35. The printer of claim 31, further comprising a control system configured to vary a concentration of the debinding liquid during the fabrication process.

36. The printer of claim 31, further comprising a circulation system operable to flow the debinding liquid between the vessel and a spout.

37. The printer of claim 31, further comprising a pump configured to control a fluid path of the debinding liquid through the vessel.

38. The printer of claim 31, wherein the robotic system is configured to move the build plate at a rate selected to minimize disturbances at a top surface of the debinding liquid.

39. The printer of claim 31, wherein the build plate includes at least one fluid channel configured to expose a bottom surface of the object to the debinding liquid.

40. A method for fabricating a three-dimensional object, comprising the steps of:
moving a nozzle relative to a build plate and depositing a plurality of successive layers of build material according to a computerized model of the object, the build material including a binder and sinterable particles;
during the step of depositing the successive layers, operating a robotic system to move the build plate into a vessel containing a debinding liquid such that the deposited build material contacts the debinding liquid.

41. The method of claim 40, further comprising the step of operating a heater in communication with the vessel to maintain a predetermined temperature within the vessel.

42. The method of claim 40, further comprising operating a level control system to maintain a predetermined position of a top surface of the debinding liquid.

43. The method of claim 40, further comprising the step of receiving an overflow of debinding liquid from the vessel to an overflow vat via an overflow drain.

44. The method of claim 40, wherein the debinding liquid includes one or more of an aqueous solvent, a non-aqueous solvent, water, ethanol, oil, a catalytic debinder, trans-dichloroethylene, limonene, hexane, perchloroethylene, and heptane.

45. The method of claim 40, further comprising the step of operating a control system to vary a concentration of the debinding liquid.

46. The method of claim 40, further comprising the step of operating a circulation system to flow the debinding liquid between the vessel and a spout.

47. The method of claim 40, further comprising the step of operating a pump to control a fluid path of the debinding liquid through the vessel.

48. The method of claim 40, wherein the robotic system is configured to move the build plate at a rate selected to minimize disturbances at a top surface of the debinding liquid.

49. The method of claim 40, wherein the build plate includes at least one fluid channel configured to expose a bottom surface of the object to the debinding liquid.

50. A method for fabricating a three-dimensional object, comprising the steps of:
forming a plurality of successive layers of build material according to a computerized model of the object, the build material including a binder and sinterable particles;
simultaneously operating a robotic system to move the plurality of successive layers into a vessel containing a debinding liquid such that the successive layers contact the debinding liquid.
